(19) United States
(12) Patent Application Publication
(10) Pub. No.: US 2017/0109048 A1
(43) Pub. Date: Apr. 20, 2017

(54) MEMORY UNIT WITH DATA SEGMENT INFORMATION IN HEADER

(71) Applicant: Hewlett Packard Enterprise Development LP, Houston, TX (US)

(72) Inventor: Jay Charles Brinkmeyer, Colorado Springs, CO (US)

(21) Appl. No.: 15/128,476

(22) PCT Filed: Mar. 31, 2014
(86) PCT No.: PCT/US2014/032332

§ 371 Date: Sep. 23, 2016

(51) Int. Cl. G06F 3/06; G06F 11/10

(52) U.S. Cl. CPC G06F 3/064; G06F 3/0619; G06F 3/0679; G06F 11/1004

(57) ABSTRACT

An example device includes at least one memory unit, the memory unit including a unit header and at least one data segment. Each data segment may include a data segment header area and at least one payload region. The unit header may include information related to a starting location of each data segment and a size of each data segment.

### BACKGROUND

Hardware components used in various applications may be provided with a memory device with data identifying the component. For example, a component may include an electrically erasable programmable read-only memory (EEPROM) which includes data identifying the product name, serial number and/or other data related to the component.

### BRIEF DESCRIPTION OF THE DRAWINGS

For a more complete understanding of various examples, reference is now made to the following descriptions taken in connection with the accompanying drawings in which:

FIG. 1 illustrates an example device with an example memory unit;

FIG. 2 illustrates a structure of an example memory area;

FIG. 3 illustrates a structure for an example unit header;

FIG. 4 illustrates a structure for an example data segment; and

FIG. 5 illustrates example process performed in reading the example memory area.

### DETAILED DESCRIPTION

As described above, certain devices may include an electrically erasable programmable read-only memory (EEPROM) which includes data identifying the product name, serial number and/or other data related to the component. For examples, various field replaceable units (FRUs) may include an EEPROM with data identifying the FRU. Such FRUs may include servers, interconnects, power supplies, fans, and other components that may be part of, for example, a blade enclosure system. An example blade enclosure system may include an onboard administrator module that manages the system and may control various components and FRUs.

In this regard, the example onboard administrator may identify each FRU using information included in the EEPROM of the FRU. In various examples described herein, the EEPROM (or other memory provided in the FRU) may be provided with a data structure that allows the EEPROM to have an arbitrary number of data components, each having an arbitrary length. Thus, the EEPROM may be provided with a data structure that is extensible to any number of application and/or environments.

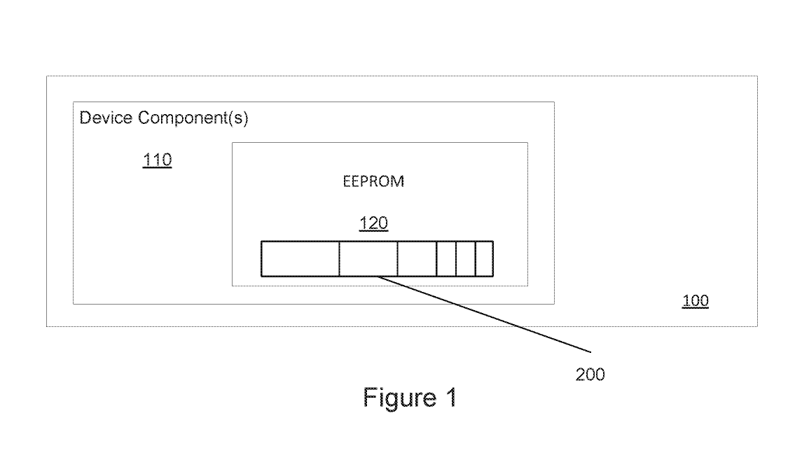

FIG. 1 is a block diagram of an example device 100, The example device 100 may be any type of component, such as an FRU in a blade enclosure system, for example. In various examples, the example device 100 may be a blade bay, a blade system midplane, a fan, a power supply, or any of a number of other components of the blade enclosure system. The example device 100 may be removable and/or replaceable with a similar or different device within the blade enclosure system.

In the example device 100 of FIG. 1, the device 100 may be provided with one or move device components 110. For example, in the case of a fan, the device 100 may include device components 110 such as a fan motor, for example. While the present disclosure describes the device 100 as an FRU, those skilled in the art will appreciate that, in various examples, the device 100 may be any of a variety of devices or components. For example, a device such as a blade enclosure may have numerous device components.

Each device component 110 of the example device 100 is provided with a memory unit 120, such as an electronically erasable programmable read-only memory (EEPROM). In various examples, the memory unit 120 contains data which may be used to identify the device 100 or the device component 110. For example, in a blade enclosure system, an onboard administrator may communicate with the device 100, which may be an FRU such as a power supply or a fan. The onboard administrator may access the memory unit 120 and read the data to identify the device 100 or the device component 110.

The memory unit 120 is provided with a memory area 200 which is structured to facilitate reading of the memory unit 120 by, for example, the onboard administrator. As described below, an example memory area 200 has a structure which allows for the memory unit 120 to contain data in an arbitrary number of data segments, each having an arbitrary length. Thus, the structure of the example memory area 200 may be extensible to a variety of current and future protocol s and environments.

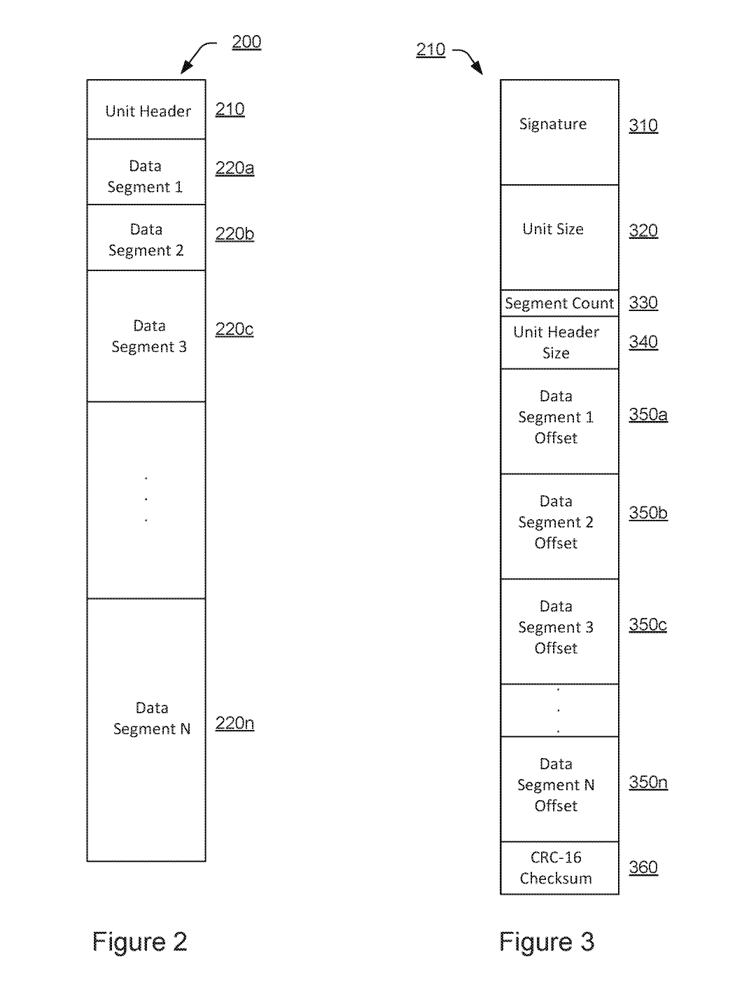

Referring now to FIG. 2, an example memory area 200 is illustrated. The structure of the example memory area 200 includes a unit header 210 and at least one data segment 220a-n. The unit header 210 may provide information regarding the number and location of each of the data segments 220a-n. In various examples, the size of the memory area 200 may be of any length as long as the size is within the limits of the physical memory unit 120. Further, the memory unit 120 may contain a single memory area 200 or multiple memory areas. In one example, the memory unit 120 contains redundant memory areas 200. In this regard, if a primary memory area 200 becomes corrupted or otherwise unreadable, the onboard administrator may use the redundant memory area to obtain identification information, for example.

Referring now to FIG. 3, an example unit header 210 is illustrated. In various examples, the total size of the unit header 210 may be arbitrary and limited only by the capability of the physical memory unit 120 to accommodate the unit header 210 and the remainder of the memory area 200. The starting point of the unit header 210 may be one of a set of predefined locations. For example, in one example, the unit header 210 starts on a 256-byte boundary. Thus, when looking for the unit header 210, the onboard administrator may look at each 256-byte boundary.

In the example of FIG. 3, the example unit header 210 begins with a signature value 310. The signature value 310 is four bytes in length in the example of FIG. 3. The signature value 310 indicates the start of the FRU Data Segment 200 memory content of, for example, a server blade within a blade enclosure. The example unit header 210 also includes a unit size block 320 which indicates the length of the entire memory area 200. In the example of FIG. 3, the unit size block 320 is a 4-byte block of information. In other examples, where unit sizes are expected to be smaller or greater, the unit size block 320 may be of a different size.

A segment count block 330 in the example unit header 210 indi.ates the number of data segments 220a-n that follow the unit header 210, A one-byte block for the segment count block 330 is sufficient to accommodate up to 255 data segments 220a-n. In examples where a larger number of data segments 220a-n is expected, the segment count block 330 may be larger. A unit header size block 340 is provided to indicate the total length of the unit header 210. In the example of FIG. 3, the unit header size block 340 is two bytes in length.

The unit header 210 includes a separate data segment offset block 350a-ncorresponding to each data segment 220a-n which follows the unit header 210. In the example of FIG. 3, each data segment offset block 350a-n is four bytes in length and indicates the memory location of each data segment. In one example, each data segment offset block 350a-n indicates the offset, in bytes, between the start of the unit header 210 and the start of the associated data segment 220a-n.

In the example of FIG. 3, a checksum block 360 is provided to include a checksum value for the entire unit header 210. The checksum value may be used for purposes of error detection upon reading of the data by, for example, the onboard administrator of a blade enclosure system. In various examples, the checksum uses a cyclical redundancy check (CRC) error detection. Of course, in other examples, different types of checksum may be used.

In the example of FIG. 3, the length of the unit header 210 is variable. For example, the length of the unit header 210 may depend on the number of data segments 220a-n, resulting in a different number of data segment offset blocks 350a-n. In other examples, the length of the unit header 210 may be fixed by providing a fixed number of data segment offset blocks 350a-n. In this regard, the number of data segment offset blocks 350a-n may be set to a sufficiently high number to accommodate expected scenarios. For unused data segment offset blocks, the value of the offset may be set to 0 to indicate unused data segment. For example, the unit header 210 may be provided with 20 data segment offset blocks 350a-n. When only 16 data segments 220a-n are provided, the last four of the data segments offset blocks 350a-n may contain a value of 0.

Of course, those skilled in the art will appreciate that the unit header 210 may contain additional blocks for additional information. For example, a data block may be provided to indicate the presence of a redundant memory area 200 and another data block indicating the location of such redundant memory area.

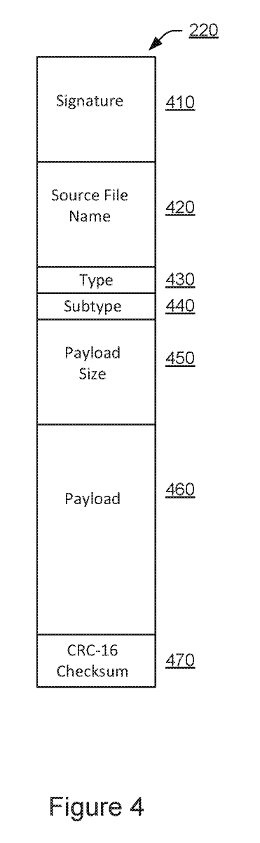

Referring now to FIG. 4, an example data segment 220 is illustrated. As noted above, the size and the location of the data segment 220 may be arbitrary and may be indicated by information in the unit header 210. In the example of FIG. 4, the data segment 220 includes a signature block 410 indicating the start of the data segment 220. The length of the example signature block 410 of FIG. 4 is four bytes, but may be selected as desired for various purposes. A source file extension block 420 is provided to indicate the name of the source file. In various examples, the source file name block 420 is an arbitrary size block of data indicating the source file name. Any unused bytes may be padded with 0's and may be ignored.

A one-byte type block 430 may indicate the type of source file. In various examples, the values of the type block 430 may indicate the type of data as follows:

| | |
|---|---|
| 1 | JavaScript Object Notation (JSON) (.json) |
| 2 | Text (.txt) |
| 3 | Graphics (.jpeg, .gif, etc.) |
| 4 | Diags (.diag) |
| 5 | Lua (.lua) |
| 6 | Scaled Vector Graphics (.svg) |
| Other | May be reserved for future use |

An additional one-byte subtype data block 440 may be provided to indicate a subtype of the data type. Subtype may also indicate whether or not the Payload block 460 has been compressed. For example, an SVG graphical payload block can be stored much more efficiently when compressed using, for example, a utility such as “GNU zip” to compress the payload bytes.

A payload size block 450 may indicate the size of the payload block 460 which follows. In the example of FIG. 4, the payload size block 450 is a 4-byte block of data which indicates the size of the payload in bytes. As indicated above, the size of the payload block 460 may be arbitrary.

As with the unit header 210, the data segment 220 may include a checksum block 470 to include a checksum value for the entire data segment 220. The checksum value may be used for purposes of error detection upon reading of the data by, for example, the onboard administrator of a blade enclosure system. In the example of FIG. 4, the checksum uses CRC error detection, but other examples may use different types of checksum.

As noted above, in various examples, the memory area 200 may include any number of data segments 220. In one example, the first data segment 220a is the primary data segment which identifies various system components by providing information such as product name, part number, serial number, configuration settings, etc. The primary data segment may include content of JSON type.

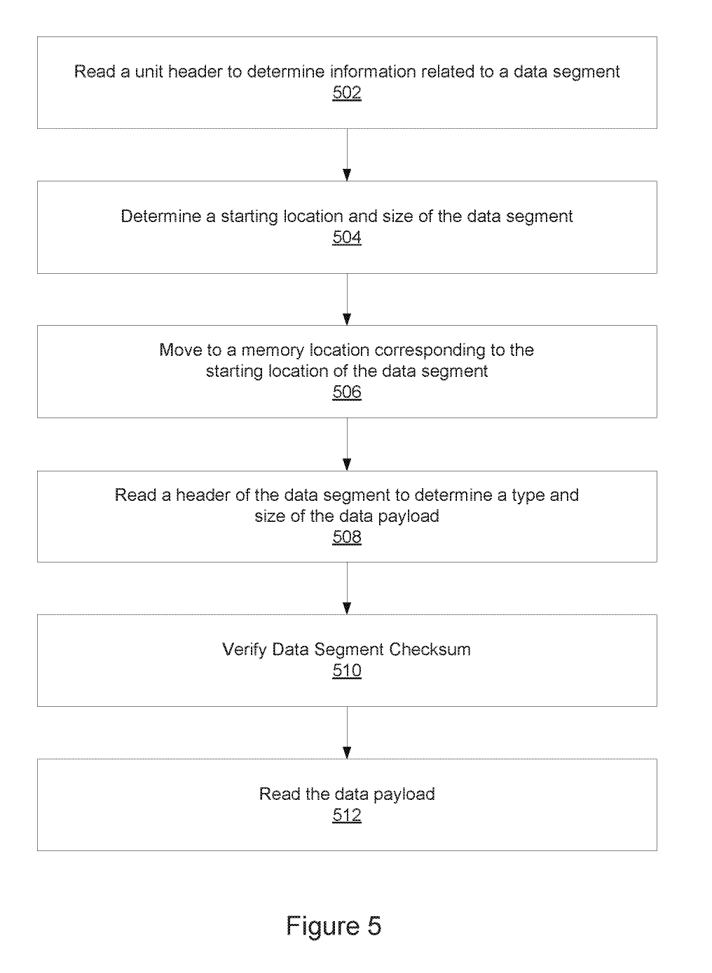

Referring now to FIG. 5, a flow chart illustrates an example process that may be performed in reading the example memory area 200 of FIGS. 2-4. The example process may be executed by, for example, the onboard administrator of a blade enclosure system to identify the various components. At block 502, the onboard administrator reads the unit header to determine information related to a data segment. In this regard, the onboard administrator may scan possible starting points for the header. For example, as noted above, a unit header may start at a 256-byte boundary.

At block 504, the onboard administrator may determine a starting memory location and a size of the data segment. As described above with reference to FIG. 3, the unit header may include information such as the size and location (e.g., data segment offset) of each data segment. The onboard administrator may then move to the memory location corresponding to the start of the data segment (block 506).

At block 508, the onboard administrator may read a header portion of the data segment to determine a type and size of the data payload. In the example of FIG. 4, the header portion may include the signature block 410, the source file extension block 420, the type block 430, the subtype block 440 and the payload size block 450. The onboard administrator may verify that the checksum value (e.g., CRC-16 checksum) in block 470 matches the computed checksum using the contents of the data payload (block 510). If the checksums match, the data payload is accepted as a valid source of device information, and the onboard administrator reads the data payload (block 512) to, for example, obtain identification information for a device or component associated with the memory area.

Thus, in accordance with the various examples described herein, a memory area may be provided that may have any arbitrary number of data segments and the data segments may be of any arbitrary size. This allows the memory area to be extensible and compatible with a variety of protocols, standards or formats.

The various examples set forth herein are described in terms of example block diagrams, flow charts and other illustrations. Those skilled in the art will appreciate that the illustrated examples and their various alternatives can be implemented without confinement to the illustrated examples. For example, block diagrams and their accompanying description should not be construed as mandating a particular architecture or configuration.

What is claimed is:

1. A device, comprising:
at least one memory unit, the memory unit including a unit header and at least one data segment, wherein the at least one data segment includes:
a data segment header area; and
at least one payload region;
wherein the unit header includes information related to the at least one data segment, the information including at least a number of data segments and a starting location of each data segment.

2. The device of claim 1, wherein the information in the unit header includes a size of the unit header.

3. The device of claim 1, further comprising at least one checksum value.

4. The device of claim 3, wherein the checksum value corresponds to one of (a) at least one data segment or (b) at least one memory unit.

5. The device of claim 3, wherein the checksum value is a cyclical redundancy check.

6. The device of claim 1, wherein the data segment header area includes information related to the payload region.

7. A memory structure, embodied on a non-transitory machine-readable medium, comprising:
at least one data unit, each data unit comprising:
a unit header; and
at least one data segment, each data segment including:
a data segment header area; and
at least one payload region,
wherein the unit header includes information related to a starting location of each data segment and a size of each data segment.

8. The memory structure of claim 7, wherein the information in the unit header includes a size of the unit header.

9. The memory structure of claim 7, further comprising at least one checksum value.

10. The memory structure of claim 9, wherein the checksum value corresponds to one of (a) at least one data segment or (b) at least one data unit.

11. The memory structure of claim 9, wherein the checksum value is a cyclical redundancy check.

12. The memory structure of claim 7, wherein the data segment header area includes information related to the payload region.

13. A method, comprising:
reading a unit header of a memory data area to determine information related to at least one data segment;
determining a starting location and a size of the at least one data segment;
moving to a memory location corresponding to the starting location of the data segment;
reading a header of at least one data segment to determine a type and a size of a data payload; and
reading the data payload.

14. The method of claim 13, further comprising:
reading a checksum value to detect errors in either the data payload or the unit header.

15. The method of claim 14, wherein the checksum value is a cyclical redundancy check value.
